(19) United States
(12) Patent Application Publication
(10) Pub. No.: US 2025/0165842 A1
(43) Pub. Date: May 22, 2025

(54) CAT QUBIT CONTAINMENT DEVICE, Z GATE AND CNOT GATE USING THIS DEVICE

(71) Applicant: INSTITUT NATIONAL DE RECHERCHE EN INFORMATIQUE ET EN AUTOMATIQUE, Le Chesnay (FR)

(72) Inventors: Ronan Gautier, Le Chesnay (FR); Alain Sarlette, Le Chesnay (FR); Mazyar Mirrahimi, Le Chesnay (FR)

(21) Appl. No.: 18/701,787

(22) PCT Filed: Oct. 3, 2022
(86) PCT No.: PCT/FR2022/051870

§ 371 Date: Apr. 16, 2024

(30) Foreign Application Priority Data
Oct. 21, 2021 (FR) 2111223

(51) Int. Cl. G06N 10/70; G06N 10/20; G06N 10/40

(52) U.S. Cl. CPC G06N 10/70; G06N 10/20; G06N 10/40

(57) ABSTRACT

A confinement device for a cat qubit includes a two-photon exchanger, a low quality-factor buffer oscillator and a high-quality factor anharmonic buffer oscillator. The oscillators are connected to the exchanger such that, when they are driven at their respective resonance frequency (ωₗ, ωₕ) and the exchanger is connected to a cat qubit oscillator, an exchange of two photons from the cat qubit oscillator with one photon from the low-quality oscillator and an exchange of two photons from the cat qubit oscillator with one photon from the high-quality oscillator respectively take place. The device implements a Hamiltonian of formula g₂ₕ((a²−α²)bh^{†}+(a²−α²)+bh)+g₂ₗ((a²−α²)^{†}bl+(a²−α²)bl^{†}) where g₂ₕ and g₂ₗ are Hamiltonian forces, a is the photon annihilation operator of the cat qubit oscillator, α is the amplitude of the cat state, bh is the photon annihilation operator of the high-quality oscillator, bₗ is the photon annihilation operator of the low-quality oscillator.

### CROSS-REFERENCE TO RELATED APPLICATIONS

This Application is a Section 371 National Stage Application of International Application No. PCT/FR2022/051870, filed Oct. 3, 2022, and published as WO 2023/067260 A1 on Apr. 27, 2023, not in English, which claims priority to French Patent Application No. 2111223, filed Oct. 21, 2021, the contents of which are hereby incorporated by references in their entireties.

### BACKGROUND OF THE DISCLOSURE

The creation of a quantum computer is currently prevented by noise modifying the state of quantum bits (hereinafter qubits), causing logical errors. Despite great progress made over the past 20 years to limit noise sources, universal and fault-tolerant quantum computing is currently out of reach. Quantum error correction aims at solving this problem.

In order to ensure fault tolerance, two types of errors will need to be corrected: bit flip errors and phase flip errors. The main methodology used aims at encoding the qubits on which a calculation sequence is specified, called “logical qubits”, in a much larger information space, composed of qubits called “physical” qubits. In this information space, the logical qubits are encoded in states called “coding” states, which are chosen so that the noise does not allow to induce a direct transition from one coding state to another.

The noise, which thus induces transitions from a coding state to a non-coding state, can be detected and corrected to bring the system back to the initial coding state in an unambiguous manner, that is to say that each non-coding state is associated with a single coding state. To avoid disrupting quantum information, this error detection and correction must be done without measuring the logical qubits. The logic gates, operating transitions from one coding state to another, can be implemented on this system in a fault-tolerant manner, through particular control sequences.

The most common quantum error correction method is called “surface code”. This type of solution is implemented by the biggest names in the quantum field, such as Google, IBM, University of Delft, University of Zurich, etc., and is the most studied solution in the world to date.

In a surface code, quantum information is carried by a 2D network of physical qubits. Schemes have been proposed to perform gates (quantum operations) with one and two fault-tolerant logic qubits. However, no demonstration of such a gate has been made to date. Indeed, the biggest disadvantage of the surface code is that it requires a large number of very good quality physical qubits to enable even the slightest calculation to be carried out. Beyond the costs induced by this architecture, this generates problems related to the need to control a large number of quantum systems.

The Applicant's work has led it to consider that a significant reduction in additional material costs is possible for error correction. For this reason, the Applicant has studied bosonic codes.

Bosonic codes are a family of quantum error-correcting codes that rely on storing physical qubits in bosonic modes. Three typical examples of these codes are: cat-codes (or ‘cat-qubits’), binomial codes, and GKP (for Gottesman-Kitaev-Preskill) codes.

An example of cat-codes are the two-component cat-codes implemented by Yale University, the Quantic team at Inria-Mines-ENS-CNRS-Sorbonne University, or companies like Quantum Circuits, Inc., Alice & Bob, or Amazon Web Services.

In these codes, the coding states (“cats”) are superpositions of coherent states of a quantum harmonic oscillator (for example of a mode of the electromagnetic field). These cat-codes allow to practically eliminate one of the two types of logical error. The second type of error can be handled by concatenating this code into a repetition code, known for non-quantum error correction. Qubits using these cat-codes are also called cat qubits.

More precisely, an advantage of these codes is that the probability of either type of error can be made arbitrarily low by simply varying the size of the cat. Thus, the article by Lescanne et al. “Exponential suppression of bit-flips in a qubit encoded in an oscillator”, Nature Physics, 16, 509, 2020 demonstrated that bit flip errors are suppressed in an exponential ratio with the average number of photons in the state of the cat qubit.

In the context of quantum error correction, a qubit with such an exponential error bias can significantly reduce the overhead required to achieve fault tolerance, that is to say the number of physical qubits it must be used together to achieve a stable logical qubit. Competing with the need for stability, it is essential to be able to execute a number of physical gates, in particular the CNOT gate while preserving the error bias. Said another way, exponential bit error suppression must remain intact during gate operation.

Currently, two approaches are considered and experimentally implemented in order to confine the dynamics of a harmonic oscillator (an infinite-dimensional space) to the variety of states of a cat qubit (a 2-dimensional space): a Hamiltonian approach called “Kerr” cat qubit and an energy dissipation approach called “dissipative” cat qubit.

The Kerr cat qubit is protected against weak Hamiltonian disturbances and enables the implementation of fast, high-fidelity quantum gates.

More specifically, Kerr cat qubits rely on qubit confinement by two-photon drive combined with Kerr-type nonlinearity, as described in the article by Puri et al., “Engineering the quantum states of light in a Kerr-nonlinear resonator by two-photon driving” npj Quantum Inf 3, 18 (2017).

In the rotating reference frame of the cat qubit mode, this scheme can be modelled by the Hamiltonian H=−K(a²−α²)^{†}(a²−α²), where K represents the intensity of the Kerr effect, Kα² is the amplitude of the two-photon drive, a represents the photon annihilation operator of the harmonic oscillator, and the index ^{†} transforms a photon annihilation operator into a photon creation operator. The variety of cat qubit states corresponds to a degenerate eigenspace of the Hamiltonian above, separated from the rest of the spectrum by a gap proportional to the intensity of the Kerr nonlinearity. This confinement scheme was recently demonstrated in an experiment by the Yale University team (see the article by Grimm et al., “Stabilization and operation of a Kerr-cat qubit”, Nature, 584, 205, 2020).

For Kerr cat qubits, the implementation of Z rotation quantum gates on a single qubit, CNOT on 2 qubits and CCNOT on 3 qubits were proposed in the article by S. Puri et. Al. “Bias-preserving gates with stabilized cat qubits”, Science Advances 6, 34, 10.1126, 2020).

However, Kerr cat qubits perform poorly against disturbances caused by broadband noise like thermal excitation or photon phase shift that naturally occur in quantum resonators, even in the absence of gates.

Indeed, in the absence of dissipative stabilisation of the cat qubit, disturbances other than slowly varying weak Hamiltonians are not countered by any mechanism and can result in significant bit flip errors. Typical error channels such as thermal excitation thus suppress the exponential error bias, and therefore block the path to hardware efficient fault tolerance.

Recently, the article by Putterman et al. “Colored Kerr cat qubits”, arXiv: 2107.09198 [quant-ph] proposed an approach to overcome this problem and ensure the suppression of bit flip errors. This approach consists of the addition of a coloured relaxation inducing an attraction towards the variety of states of the cat qubit. With this addition, bit error suppression is restored for the Kerr cat qubit. However, in order to achieve the same level of performance as in the case of a dissipative cat qubit, careful environmental engineering beyond the Purcell filters that are commonly used in superconducting devices is necessary. This task is extremely difficult to perform from an experimental point of view, and offers limited bit flip protection prospects.

On the other side, the dissipative cat qubit is designed to counter all these decoherence mechanisms, but the performance of quantum gates is limited by the nonadiabatic dissipative processes that result in information loss during the operation.

This approach is based on two-photon dissipation that confines the dynamics to only the two stable states of the system, as described in the paper by Mirrahimi et al., “Dynamically protected cat-qubits: a new paradigm for universal quantum computation» 2014 New J. Phys. 16 045014).

As mentioned above, a recent experiment demonstrated exponential bit error suppression with this cat qubit dissipative confinement scheme. In this experiment, the confinement is achieved using a superconducting circuit element called ATS (for “Asymmetrically Threaded SQUID”). The cat qubit, encoded in a harmonic oscillator, is coupled to a buffer oscillator using an ATS. The buffer oscillator is highly dissipative and its energy damping is much faster than that of the mode hosting the cat qubit. The buffer oscillator is called “low Q” oscillator (where Q stands for quality factor) due to its short lifetime, while the oscillator hosting the cat qubit is called “high Q” oscillator.

More specifically, in this dissipative approach, a Hamiltonian which carries out the exchange of two photons from the oscillator hosting the cat qubit with one photon from the low Q buffer oscillator is first implemented. In the rotating reference frame of the two oscillators: H₂ₚₕ=g₂(a²b^{†}+a^{2†}b), where a represents the photon annihilation operator of the cat qubit oscillator, and b represents the photon annihilation operator of the buffer oscillator, and the index ^{†} transforms a photon annihilation operator into a photon creation operator. Therefore, this Hamiltonian can be understood as an exchange of two photons from the oscillator a with one photon of the oscillator b.

In addition, the rate of this exchange can be calibrated by the amplitude of a microwave pump applied to the ATS device. It is then necessary to drive the buffer oscillator resonantly. In the rotating reference frame of the buffer oscillator, this can be modelled by the Hamiltonian Ha=eb^{†}+e*b, which, by choosing e=g₂α² the complex amplitude of the resonant drive, gives the resultant Hamiltonian H=g₂((a²−α²)b^{†}+(a²−α²)^{†}+b). However, due to its low quality factor, the oscillator b has a strong damping. This one-photon damping therefore of the form κ1D(b) of the oscillator b, effectively results in a dissipation of the form κ₂D(a²−α²) on the oscillator a, which is called two-photon dissipation and which allows to confine the states of cat qubits with an amplitude α.

The article by J. Guillaud et. al. “Repetition Cat Qubits for Fault-Tolerant Quantum Computation” (Physical Review X 9, 041053, 2019) proposes architectures for performing one-qubit Z rotations, and two-qubit CNOT (also called CX) and three-qubit CCNOT (also called CCX or Toffoli) gates from dissipative cat qubits.

In the case of the CNOT gate, which is an essential gate for error correction, this dissipative implementation is based on modifying the dissipation term for the target cat qubit to make it dependent on the state of the control cat qubit. Control cat qubit means the qubit whose state will influence the target cat qubit.

By abuse of language, it is considered that this term of dissipation “attracts” the state of the system towards the ideal path that it should follow. To improve the performance of the gate, it is necessary to avoid the shift in relation to the ideal path which necessarily appears when there is only a mechanism which “attracts”, it is also necessary to design a feedforward Hamiltonian which simultaneously “pushes” the state of the system along this same path. Experimentally speaking, the dissipation terms can be implemented by the ATS and using coupling to the low Q buffer oscillator, while the feedforward term can be implemented by a driven nonlinear coupling between the two control and target cat qubit oscillators. The inability to implement an exact feedforward term necessarily results in dissipation, which is accompanied by phase flip errors. The faster the gate—therefore the more the dissipation “pulls”—the more the phase error increases.

The main disadvantage of this approach is the limited performance of logic gates in terms of phase flip errors. As detailed in the article by J. Guillaud et al. mentioned above, various error bias-preserving gates, such as one-qubit rotations around the axis Z, two-qubit CNOT and three-qubit CCNOT gates, rely explicitly on the dissipative mechanism since their ideal Hamiltonian implementation is currently experimentally unrealistic. This dissipative correction of the gates is accompanied by phase flip errors, which increase with the speed of the gates.

### SUMMARY

An exemplary embodiment of the present disclosure improves the situation. To this end, it proposes a confinement device for cat qubit comprising a two-photon exchanger, a low quality factor buffer oscillator and a high quality factor anharmonic buffer oscillator, wherein the low quality factor buffer oscillator and the high quality factor anharmonic buffer oscillator are connected to the two-photon exchanger such that, when they are both driven at their respective resonance frequency and the two-photon exchanger is connected to a cat qubit oscillator, an exchange of two photons from the cat qubit oscillator with one photon from the low quality factor buffer oscillator and an exchange of two photons from the cat qubit oscillator with one photon from the high quality factor anharmonic buffer oscillator respectively take place, and the confinement device implements a Hamiltonian of formula g₂ₕ((a²−α²)bh^{†}+(a²−α²)^{†}bh)+g₂ₗ((a²−α²)^{†}bl+(a²−α²)bl^{†}) where g₂ₕ and g₂ₗ are Hamiltonian forces, a is the photon annihilation operator of the cat qubit oscillator, α is the amplitude of the cat state, bh is the photon annihilation operator of the high quality factor anharmonic buffer oscillator, bl is the photon annihilation operator of the low quality factor buffer oscillator.

This device is particularly advantageous because it allows the implementation of a confinement device which benefits from both the advantages of the dissipative approach and the Hamiltonian approach, which allows to maintain an error bias for a very wide class of physical disturbances, while allowing to perform gates whose speed and fidelity are satisfactory.

According to various embodiments, the invention may have one or more of the following features:
the device comprises two two-photon exchangers, one being disposed between the low quality factor buffer oscillator and the cat qubit oscillator, and the other being disposed between the high quality factor anharmonic buffer oscillator and the cat qubit oscillator,
the two-photon exchanger and the high quality factor anharmonic buffer oscillator are produced by an ATS circuit with asymmetric junction Josephson energies, which is driven resonantly at the frequency ωₕ and to which are applied two radiofrequency flux pumps with respective frequencies 2ωₐ−ωₕ and 2ωₐ−ωₗ, ωₐ being the resonance frequency of the cat qubit oscillator mode, or is the resonance frequency of the low quality factor buffer oscillator, and ωₕ is the resonance frequency of the high quality factor anharmonic buffer oscillator, the ATS circuit being coupled to the low quality factor buffer oscillator, driven resonantly at the frequency ωₗ, the low quality factor buffer oscillator being coupled to a dissipative bath,
the two-photon exchanger and the low quality factor buffer oscillator are produced by an ATS circuit with symmetrical junction Josephson energies, which is driven resonantly at the frequency ωₗ and to which are applied two radiofrequency flux pumps with respective frequencies 2ωₐ−ωₕ and 2ωₐ−ωₗ, ωₐ being the resonance frequency of the cat qubit oscillator mode, ωₗ is the resonance frequency of the low quality factor buffer oscillator, and ωₕ is the resonance frequency of the high quality factor anharmonic buffer oscillator, the ATS circuit being coupled to a high quality factor anharmonic buffer oscillator, driven resonantly at the frequency ωₕ, and to a dissipative bath, and
the high quality factor anharmonic buffer oscillator is a transmon.

The invention also relates to a Z gate for a cat qubit, comprising a confinement device according to the invention whose two-photon exchanger is connected to a cat qubit oscillator, wherein said gate is executed by driving the cat qubit oscillator for a chosen duration with a Zeno-type Hamiltonian whose amplitude ε_{Z}(t) satisfies the equation 4 ∫₀^{T} Re(αε_{Z}(t))dt=∂ where α is the size of the cat qubit, Re( ) designates the real part, and T is the duration of the gate, and ∂ is the angle of rotation around the axis Z.

The invention also relates to a CNOT gate for cat qubits, comprising a control cat qubit comprising a confinement device, the two-photon exchanger of which is connected to a cat qubit oscillator and a target cat qubit comprising a confinement device, the two-photon exchanger of which is connected to a cat qubit oscillator, and a nonlinear coupler connecting the cat qubit oscillator of the control cat qubit and the cat qubit oscillator of the control cat qubit, wherein the gate is executed by deactivating the target cat qubit confinement device.

In this CNOT gate the nonlinear circuit can be a Josephson junction which implements a Zeno-type Hamiltonian of form ε_{CX}(â_{co}+â_{co}^{†}−2α)(â_{ci}^{†}â_{ci}−α²) where ε_{CX} is the Hamiltonian amplitude, â_{co} and â_{co}^{†} are the photon annihilation and creation operators for the control qubit harmonic oscillator, â_{ci} and â_{ci}^{†} are the photon annihilation and creation operators for the target qubit harmonic oscillator, and a is the size of the cat state, the amplitude ε_{CX}(t) satisfying the equation 4 ∫₀^{T} Re(αε_{CX}(t))dt=π where α is the size of the cat qubit, Re( ) denotes the real part, and T is the gate execution time.

In this CNOT gate, the Hamiltonian g₂ₗ((a²−α²)^{†}+bl+(a²−α²)bl^{†}) of the control qubit confinement device is always implemented, the Hamiltonian g₂ₕ((a²−α²)bh^{†}+(a²−α²)^{†}bh) of the control cat qubit confinement device is implemented at least during the execution of the gate, the Hamiltonian g₂ₗ((a²−α²)^{†}bl+(a²−α²)bl^{†}) of the target cat qubit confinement device is not implemented during the execution of the CNOT gate and is implemented for the rest of the time, and the Hamiltonian g₂ₕ((a²−α²)bh^{†}+(a²−α²)^{†}bh) of the target cat qubit confinement device is not implemented during the execution of the gate.

### BRIEF DESCRIPTION OF THE DRAWINGS

Other features and advantages of the invention will appear better upon reading the description which follows, taken from examples given in an illustrative and non-limiting manner, taken from the drawings wherein:

FIG. 1 shows a generic diagram for producing a cat qubit confinement device according to a first embodiment of the invention,

FIG. 2 shows a generic diagram of a cat qubit confinement device according to a second embodiment of the invention,

FIG. 3 shows a first example of implementation of the confinement device of FIG. 1,

FIG. 4 shows a second example of implementation of the confinement device of FIG. 1,

FIG. 5 shows a generic diagram of a CNOT gate between two cat qubits implementing the confinement device of FIG. 1,

FIG. 6 shows an example of implementation of the gate of FIG. 5 with a cat qubit confinement device of FIG. 3, and

FIG. 7 shows the amplitudes of the Hamiltonians of the gate of FIG. 6.

### DETAILED DESCRIPTION OF ILLUSTRATIVE EMBODIMENTS

The drawings and description below contain, for the most part, elements of a certain nature. They can therefore not only be used to better understand the present invention, but also contribute to its definition, if necessary.

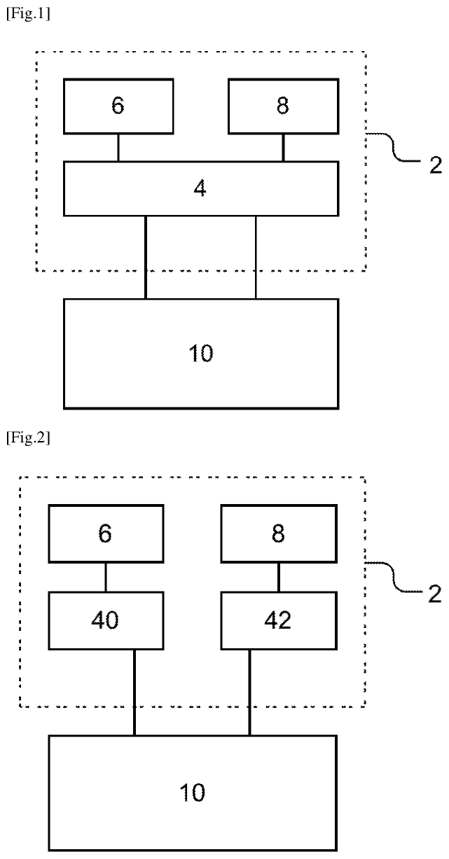

FIG. 1 shows a generic diagram of a cat qubit confinement device according to a first embodiment of the invention, as well as the oscillation modes within it. As will appear below, the confinement device 2 has a confinement which can be described as “dissipative-conservative”.

The cat qubit confinement device 2 comprises a nonlinear excitation quanta exchanger, more concretely called a two-photon exchanger 4, a low quality factor buffer oscillator 6 and a high quality factor anharmonic buffer oscillator 8.

In the example described here, the two-photon exchanger 4 is arranged to have two connections to an oscillator hosting the cat qubit 10 stabilised by the confinement device. These two connections represent a sort of external interface of the confinement device 2. A low quality factor buffer oscillator 6 and a high quality factor anharmonic buffer oscillator 8 are also connected to the two-photon exchanger 4, but this times inside the confinement device 2.

As illustrated in FIG. 2, this arrangement can be seen as two parallel connections:
on the one hand between the low quality factor buffer oscillator 6 and the oscillator hosting the cat qubit 10, a two-photon exchanger 40 being disposed therebetween, and
on the other hand between the high quality factor anharmonic buffer oscillator 8 and the oscillator hosting the cat qubit 10, a two-photon exchanger 42 being disposed therebetween.

More specifically, thanks to a coherent four-wave mixing process and the application of a microwave pump at an appropriate frequency, the two-photon exchanger 4 (respectively 40) can exchange two excitation quanta of the cat qubit 10 oscillator with an excitation quantum of the low quality factor buffer oscillator.

Since the low quality factor buffer oscillator is highly dissipative, this process of one-photon loss of the buffer oscillator effectively leads to a two-photon loss of the cat qubit oscillator. In an inverse process, the low quality factor buffer oscillator itself being driven at its resonance frequency, the addition of one photon to the buffer oscillator effectively induces the addition of two photons to the oscillator hosting the cat qubit. These two mechanisms together provide dissipative confinement, while the stabilisation rate and amplitude of the cat can be tuned by the microwave pump controlling the two-photon exchanger and the resonant drive on the low quality factor buffer oscillator. This interaction provides a dissipation Hamiltonian g₂ₗ((a²−α²)bl^{†}+(a²−α²)^{†}bl), where the strength of the Hamiltonian g₂ₗ and the amplitude α of the cat can be adjusted by the microwave pump and the resonant drive of the low quality factor buffer oscillator 6, and where bl is the photon annihilation operator of the low quality factor buffer oscillator 6 and † is an index which transforms a photon annihilation operator into a photon creation operator.

At the same time, a second pump at an appropriate frequency applied to the same two-photon exchanger (or to a second two-photon exchanger in the embodiment of FIG. 2) establishes an exchange between two photons from the cat qubit oscillator and one photon from the high quality factor anharmonic buffer oscillator. This interaction, associated with a resonant drive of the high quality factor buffer oscillator, provides an effective confinement Hamiltonian g₂ₕ((a²−α²)bh+(a²−α²)^{†}+bh), where the strength of the Hamiltonian g₂ₕ and cat amplitude α can be adjusted by the microwave pump and the resonant drive of the high quality factor buffer oscillator, and where bh is the photon annihilation operator of the high quality factor buffer oscillator 8 and † is an index that transforms a photon annihilation operator into a photon creation operator.

FIGS. 1 and 2 have been described with reference to photon exchanges because the examples described here use superconducting circuit qubits which operate by photon exchange. In other variants, the qubits could be made mechanically, and the two-photon exchanger could be a two-phonon exchanger or a two-photon-for-one-photon exchanger. Generally speaking, the exchanger 4 is arranged to exchange excitation quantums, which can be photons or phonons.

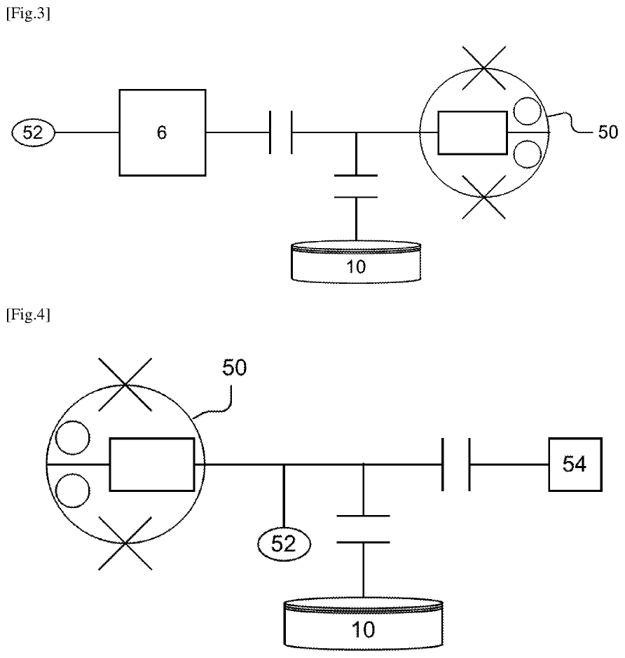

FIG. 3 shows a first example of implementation of the embodiment of FIG. 1. In the example described here, an ATS 50 (for “Asymmetrically Threaded SQUID”) circuit is used to implement the two-photon exchanger 4.

As described in the article by Lescanne et al. mentioned above, the ATS comprises a SQUID equipped with a parallel inductor. Different constant magnetic fluxes can be applied to the two loops of the ATS. In the mentioned article, the junctions of the ATS are perfectly symmetrical, while the operating point is a normalised flux (ratio between the applied magnetic flux and the quantum of the magnetic flux) of 0 in a loop and a normalised flux of x in the other, hence the “asymmetric” name of the dipole. This choice allows to remove all even-wave mixing terms and, with the application of an appropriate alternating pump, to design an efficient two-photon exchange Hamiltonian, without disturbances such as self-Kerr or crossed Kerr terms.

The Applicant has discovered that controlling the amplitude of the odd-wave mixing terms relative to the even-wave mixing terms, obtained by changing the Josephson energies of the ATS junctions, allows to add a Hamiltonian confinement compatible with known dissipative confinement.

Thus, in the example described here, the ATS 50 is coupled to the cat qubit 10 oscillator in a manner similar to what is described in the article by Lescanne et al., but the mode hosted by the circuit of the ATS is not sufficient to implement the entire confinement system. Thus, the ATS 50 is also strongly coupled to a buffer oscillator, which is proposed by this example at a low quality factor 6 and coupled to a dissipative bath 52, while the high quality factor buffer oscillator 8 is hosted by the circuit of the ATS. By applying two radiofrequency flux pumps with respective frequencies 2ωₐ−ωₕ and 2ωₐ−ωₗ, the ATS 50 implements two two-photon exchange Hamiltonians g₂ₕ(a²h^{†}−a^{2†}h) and g₂ₗ(a²l^{†}−a^{2†}l) with respectively a high Q mode 8 and a low Q mode 6 at the respective resonance frequencies ωₕ and ωₗ while ωₐ is the resonance frequency of the cat qubit mode.

When these modes are driven at their resonance, the effective Hamiltonians are g₂ₕ((a²−α²)bh^{†}+(a²−α²)^{†}bh) and g₂ₗ((a²−α²)bl^{†}+(a²−α²)^{†}bl). In the proposed scheme, the buffer oscillator is a low quality factor harmonic oscillator 6, with bl its photon annihilation operator, while the high Q oscillator is anharmonic, with bh the annihilation operator of an excitation between its two fundamental levels. Furthermore, this high-Q anharmonic oscillator can be one of the modes of the ATS circuit.

The Hamiltonian g₂ₕ((a²−α²)bh^{†}+(a²−α²)^{†}bh) provides the conservative confinement allowing the implementation of fast gates, while the Hamiltonian g₂ₗ((a²−α²)bl^{†}+(a²−α²)^{†}bl), by its connection with the mode bl of the low quality factor buffer oscillator has a strong dissipation, resulting in a dissipative confinement of the form κ₂D(a²−α²), which ensures the exponential elimination of bit flip errors, in the presence of a very broad class of physical disturbances.

FIG. 4 shows a second example of implementation of the embodiment of FIG. 1.

In this example, the ATS 50 again plays the role of the two-photon exchanger 4, but instead of also playing the role of the high quality factor anharmonic buffer oscillator 8, it plays the role of the low quality factor buffer oscillator 6 and is connected to a dissipative bath 52. The high quality factor anharmonic buffer oscillator is here implemented by a transmon qubit 54 (for “transmission line shunted plasma oscillation qubit”), which is nonlinear and with a high quality factor by design. Indeed, a transmon is conceptually similar to a harmonic oscillator composed of an inductor and a capacitor in parallel. In the case of the transmon, the inductance is replaced by another inductive electronic component, the Josephson junction, which is naturally nonlinear. By changing the energy ratio between the junction and the capacitor, the transmon parameter regime can be achieved, which implements a high quality factor nonlinear mode.

In the embodiment of FIG. 1, the low quality factor buffer oscillator 6 does not need to be anharmonic. Thus, the junctions of the ATS 50 should be chosen symmetrical in order to eliminate the auto Kerr and crossed Kerr effects, only the applied fluxes will be asymmetrical as in the article by Lescanne et al. mentioned above.

In the case of FIG. 3 as in that of FIG. 4, it is possible to perform a Z gate by applying a Hamiltonian to the cat qubit oscillator.

In order to perform a Z gate, a Zeno-type Hamiltonian is turned on. A Zeno-type Hamiltonian is a Hamiltonian whose effective dynamic projected into the coding space-here the coding space is the space composed of the two states of the cat qubit-corresponds to the desired operation, here a rotation around the axis Z of the qubit. An example of a Zeno-type Hamiltonian for a Z gate on a cat qubit is a one-photon drive Hamiltonian, of the form ε_{Z}â+ε_{Z}*â^{†}, where â and â^{†} are the photon annihilation and creation operators of the cat qubit harmonic oscillator, and where ε_{Z} is the amplitude of the drive. This Hamiltonian can be performed experimentally with a resonant drive of the harmonic oscillator hosting the cat qubit. To perform a Z gate of rotation angle ∂, the amplitude ε_{Z}(t) of the drive must satisfy the equation 4 ∫₀^{T} Re(αε_{Z}(t))dt=∂ where α is the size of the cat qubit, Re( ) denotes the real part, and T is the duration of the Z gate performed.

In the examples described here, the convention used for the coding states of a cat qubit is as follows. The logical states ‘0’ and ‘1’ of a cat qubit are defined by

$${{\vert 0 〉}_{L} = \frac{1}{\sqrt{2}} ( \vert {C}_{α}^{+} 〉 + \vert {C}_{α}^{-} 〉 ) and \vert 1 〉}_{L} = \frac{1}{\sqrt{2}} ( \vert {C}_{α}^{+} 〉 - \vert {C}_{α}^{-} 〉 ) ,$$

where the states C_{α}⁺ and C_{α}⁻ are the superposition states defined by |C_{α}^{±} [symbol] =(|α [symbol] ±|−α [symbol] )/∥|α [symbol] ±|−α [symbol] | where |±α [symbol] are coherent states of a quantum harmonic oscillator of size α, and where ∥ ∥ denotes the norm of the quantum state.

There is another convention where the logic states ‘0’ and ‘1’ are defined by |0 [symbol] _{L}=|C_{α}⁺ [symbol] and |1 [symbol] _{L}=|C_{α}⁻ [symbol] . In this case, the Z gate described herein becomes an X gate (rotation of the qubit around its axis X in the Bloch sphere).

FIG. 5 shows a generic diagram of a CNOT gate between a cat qubit 60, called “control” cat qubit, and a cat qubit 62, called “target” cat qubit, both associated with a confinement device according to the embodiment of FIG. 1. As can be seen in this figure, the gate is implemented by placing two cat qubits provided with a confinement device 2 in series according to the embodiment of FIG. 1, the oscillators of the cat qubits 60 and 62 being connected together by an anharmonic coupler 64 the role of which is to implement a Zeno-type Hamiltonian, the turning on of which will be simultaneous with the turning off of the confinement device 2 of the target cat qubit 62. The confinement device of the control cat qubit nevertheless remains effective.

An example of a Zeno-type Hamiltonian for a CNOT gate on cat qubits is a three-photon coupling Hamiltonian of the form ε_{CX}(â_{co}+â_{co}^{†}−2α)(â_{ci}^{†}â_{ci}−α²) where ε_{CX} is the amplitude of the Zeno-type Hamiltonian, â_{co} and ât, are the photon annihilation and creation operators for the control qubit harmonic oscillator, â_{ci} and â_{ci}^{†} are the photon annihilation and creation operators for the target qubit harmonic oscillator, and a is the size of the cat state. In the case where the nonlinear coupler is a Josephson junction, the Zeno-type Hamiltonian can be applied by pumping the target qubit harmonic oscillator at the resonance frequency of the control qubit harmonic oscillator, and by resonantly driving the control qubit harmonic oscillator. The generation of this Zeno-type Hamiltonian is described in the article by S. Touzard, et. al. “Gated Conditional Displacement Readout of Superconducting Qubits”, Phys. Rev. Letters 122, 080502, 2019. To perform a CNOT gate, the amplitude ε_{CX}(t) of the Zeno-type Hamiltonian must satisfy the equation 4 ∫₀^{T} Re(αε_{CX}(t))dt=π where α is the size of the cat qubit, Re( ) denotes the real part, and T is the duration of the CNOT gate performed.

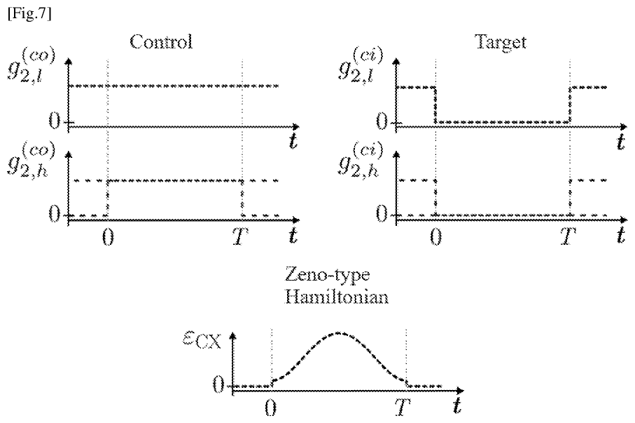

The sequence of turning off and turning on the confinement devices and the Zeno-type Hamiltonian is shown in FIG. 7. As can be seen in this figure:
the dissipative confinement of the control cat qubit must always be turned on,
the conservative confinement of the control cat qubit must at least be turned on while the CNOT gate is turned on,
the dissipative confinement of the target cat qubit must be turned off while the CNOT gate is turned on, and be turned on the rest of the time, and
the conservative confinement of the target cat qubit must be turned off while the CNOT gate is turned on, and can be turned on or off the rest of the time.

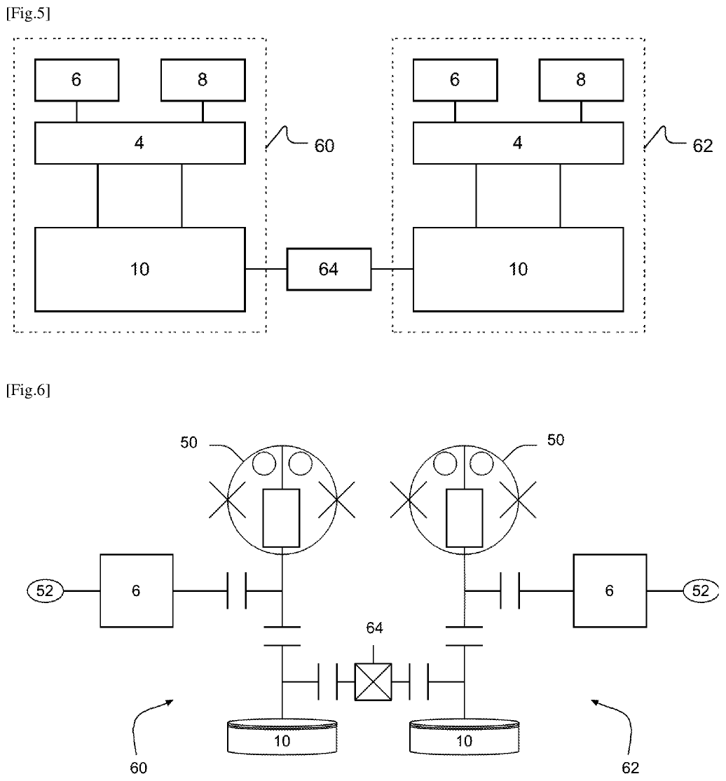

As can be seen in FIG. 6, the nonlinear coupler 64 may be a Josephson junction capacitively coupled to the cat qubit oscillators 60 and 62, as described in the article by S. Touzard, et. al. “Gated Conditional Displacement Readout of Superconducting Qubits”, Phys. Rev. Letters 122, 080502, 2019. By driving the oscillators of the cat qubits in resonance with an amplitude adapted over time, the Josephson junction 64 implements a Zeno-type Hamiltonian which induces the results presented at the bottom of FIG. 7.

Although the present disclosure has been described with reference to one or more examples, workers skilled in the art will recognize that changes may be made in form and detail without departing from the scope of the disclosure and/or the appended claims.

1. A confinement device for cat qubit comprising:
a two-photon exchanger;
a low quality factor buffer oscillator; and
a high quality factor anharmonic buffer oscillator,
the low quality factor buffer oscillator and the high quality factor anharmonic buffer oscillator being connected to the two-photon exchanger such that, when they are both driven at their respective resonance frequency (ωₗ, ωₕ) and the two-photon exchanger is connected to a cat qubit oscillator, an exchange of two photons from the cat qubit oscillator with one photon from the low quality factor buffer oscillator and an exchange of two photons from the cat qubit oscillator with one photon from the high quality factor anharmonic buffer oscillator respectively take place, and the confinement device implements a Hamiltonian of formula g₂ₕ((a²−α²) bh^{†}+(a²−α²)^{†}bh)+g₂ₗ((a²−α²)^{†}bl+(a²−α²)bl^{†}) where g₂ₕ and g₂ₗ are Hamiltonian forces, a is a photon annihilation operator of the cat qubit oscillator, α is an amplitude of the cat state, bh is a photon annihilation operator of the high quality factor anharmonic buffer oscillator, bₗ is a photon annihilation operator of the low quality factor buffer oscillator.

2. The confinement device according to claim 1, wherein the two-photon exchanger comprises a first two-photon exchanger disposed between the low quality factor buffer oscillator and the cat qubit oscillator, and a second two-photon exchanger disposed between the high quality factor anharmonic buffer oscillator and the cat qubit oscillator.

3. The confinement device according to claim 1, wherein the two-photon exchanger and the high quality factor anharmonic buffer oscillator are formed by an Asymmetrically Threaded SQUID (ATS) circuit with asymmetric junction Josephson energies, which is driven resonantly at the frequency ωₕ and to which are applied two radiofrequency flux pumps with respective frequencies 2ωₐ−ωₕ and 2ωₐ−ωₗ, ωₐ being the resonance frequency of the cat qubit oscillator mode, ωₗ is the resonance frequency of the low quality factor buffer oscillator, and ωₕ is the resonance frequency of the high quality factor anharmonic buffer oscillator, the ATS circuit being coupled to the low quality factor buffer oscillator, driven resonantly at the frequency ωₗ, the low quality factor buffer oscillator being coupled to a dissipative bath.

4. The confinement device according to claim 1, wherein the two-photon exchanger and the low quality factor buffer oscillator are formed by an Asymmetrically Threaded SQUID (ATS) circuit with symmetrical junction Josephson energies, which is driven resonantly at the frequency ωₗ and to which are applied two radiofrequency flux pumps with respective frequencies 2ωₐ−ωₕ and 2ωₐ−ωₗ, ωₐ being the resonance frequency of the cat qubit oscillator mode, ωₗ is the resonance frequency of the low quality factor buffer oscillator, and ωₕ is the resonance frequency of the high quality factor anharmonic buffer oscillator, the ATS circuit (50) being coupled to a high quality factor anharmonic buffer oscillator, driven resonantly at the frequency ωₕ, and to a dissipative bath.

5. The device according to claim 4, wherein the high quality factor anharmonic buffer oscillator is a transmon.

6. A Z gate for a cat qubit, comprising:
the confinement device according to claim 1,
wherein the two-photon exchanger of the confinement device is connected to the cat qubit oscillator, wherein said gate is executed by driving the cat qubit oscillator for a chosen duration with a Zeno-type Hamiltonian whose amplitude ε_{Z}(t) satisfies the equation 4 ∫₀^{T} Re(αε_{Z}(t))dt=∂ where α is the size of the cat qubit, Re( ) designates the real part, and T is the duration of the gate, and ∂ is the angle of rotation around the axis Z.

7. A CNOT gate for cat qubits, comprising:
a control cat qubit comprising a first confinement device according to claim 1, wherein the two-photon exchanger of the first confinement device is connected to a first cat qubit oscillator;
a target cat qubit comprising a second confinement device according to claim 1, the two-photon exchanger of the second confinement device is connected to a second cat qubit oscillator; and
a nonlinear coupler connecting the first cat qubit oscillator of the control cat qubit and the second cat qubit oscillator of the control cat qubit, wherein the gate is executed by deactivating the second confinement device of the target cat qubit.

8. The CNOT gate according to claim 7, wherein the nonlinear coupler is a Josephson junction which implements a Zeno-type Hamiltonian of form ε_{CX}(â_{co}+â_{co}^{†}−2α)(â_{ci}^{†}â_{ci}−α²) where ε_{CX} is the Hamiltonian amplitude, â_{co} and â_{co}^{†} are the photon annihilation and creation operators for the control qubit harmonic oscillator, â_{ci} and â_{ci}^{†} are the photon annihilation and creation operators for the target qubit harmonic oscillator, and α is the size of the cat state, the amplitude ε_{CX}(t) satisfying the equation 4 ∫₀^{T} Re(αε_{CX}(t))dt=π where α is the size of the cat qubit, Re( ) denotes the real part, and T is the gate execution time.

9. The CNOT gate according to claim 7, wherein the Hamiltonian g₂ₗ((a²−α²)^{†}+bl+(a²−α²)bl^{†}) of the first confinement device of the control cat qubit is always implemented, the Hamiltonian g₂ₕ((a²−α²)bh^{†}+(a²−α²)^{†}+bh) of the first confinement device is implemented at least during the execution of the gate, the Hamiltonian g₂ₗ((a²−α²)^{†}bl+(a²−α²)bl^{†}) of the second confinement device of the target cat qubit is not implemented during the execution of the CNOT gate and is implemented for the rest of the time, and the Hamiltonian g₂ₕ((a²−α²)bh^{†}+(a²−α²)^{†}bh) of the second confinement device of the target cat qubit is not implemented during the execution of the gate.
